(19) United States
(12) Patent Application Publication
(10) Pub. No.: US 2017/0227024 A1
(43) Pub. Date: Aug. 10, 2017

(54) HYDRAULIC DRIVE SYSTEM FOR A POST DRIVER OF A SKID STEER LOADER

(71) Applicant: HCC, INC., Mendota, IL (US)

(72) Inventor: Bruce Lee Masters, GRAETTINGER, IA (US)

(21) Appl. No.: 15/358,777

(22) Filed: Nov. 22, 2016

Related U.S. Application Data
(60) Provisional application No. 62/293,182, filed on Feb. 9, 2016.

(51) Int. Cl. F15B 7/08; F15B 1/26; B62D 11/00

(52) U.S. Cl. CPC F15B 7/08; B62D 11/005; F15B 1/26

(57) ABSTRACT

A hydraulic system for driving a post driver of a skid steer loader. The hydraulic system includes a master cylinder disposed between a valve, such as a 4-way valve, and the driver cylinder of the post driver. The master cylinder effectively provides that hydraulic fluid from the 4-way valve to the hydraulic system of the skid steer loader can flow freely without needing an auxiliary pump and motor to overcome resistance in the return line back to the skid steer loader hydraulic system. By eliminating the restriction in the return line of the driver cylinder, a very fast retraction can be achieved, improving the impact performance of the system.

### RELATED APPLICATION (PRIORITY CLAIM)

This application claims the benefit of U.S. Provisional Application Ser. No. 62/293,182, filed Feb. 9, 2016, which is hereby incorporated herein by reference in its entirety.

### BACKGROUND

The present invention generally relates to hydraulic drive systems for skid steer loaders, and more specifically relates to a hydraulic drive system used to drive, for example, a post driver mounted on a skid steer loader.

Typically, a post driver which is mounted on a skid steer loader is driven using the skid steer loader implement hydraulic system. Such a system 8 is shown in FIG. 1, and includes attaching a 4-way valve 104 and a driver cylinder 18 (explained further later) to the skid steer system to operate the driver cylinder 18 up and down. However, the skid steer hydraulic system 32 return to tank line 30 has enough restriction so as to impede the retraction of the driver cylinder 18 and thereby diminish the impact force required to drive the post.

For this reason, improvement was effected—an auxiliary hydraulic system 10 as shown in FIG. 2 was incorporated into the system to allow free flow retraction (descent) of the driver cylinder 18 without the negative effects of the flow restriction of the skid steer hydraulic system return line 30. A post driver, which is mounted on a skid steer loader with this type of flow improvement, is driven using an auxiliary hydraulic system (i.e., a skid steer loader implement hydraulic system) which is in addition to the skid steer loader hydraulic system. Such an auxiliary hydraulic system 10 (shown in FIG. 2) may include an auxiliary hydraulic motor 12 coupled to an auxiliary hydraulic pump 14 via auxiliary coupling 16. This auxiliary motor 12 and pump 14 is used to power (i.e., drive) the driver cylinder 18 of the post driver. Specifically, hydraulic pressure drives the driver cylinder 18 of the post driver up, and then that hydraulic pressure is vented to allow the driver cylinder 18 of the post driver to drop due to gravity, i.e., assisted by the driver cylinder's own weight, and assisted by a spring return 20.

The system 10 provides that auxiliary system hoses 22 connect the auxiliary hydraulic pump 14 to an auxiliary reservoir 24 and a 4-way valve 26. The 4-way valve 26 is manually controlled by a human operator, to dictate whether the post driver drive cylinder 18 is driven up by the hydraulic system, or is allowed to fall down (driven by its own weight, and assisted by the spring return 20). In FIG. 2, supply line 28 provides hydraulic fluid flow to this auxiliary hydraulic system 10, while return line 30 allows hydraulic fluid flow from this auxiliary hydraulic system 10 to the hydraulic system 32 of the skid steer loader.

As shown in FIG. 2, the hydraulic system 32 of the skid steer loader may include, among other things, a skid steer loader implement pump 34 (i.e., for pumping hydraulic fluid to the auxiliary hydraulic system 10), skid steer loader hydrostatic propel pumps 36 and skid steer loader hydrostatic propel motors 38 (i.e., for propelling the skid steer loader), a charge relief valve 40, replenishing valves 42, a skid steer loader hydraulic tank (i.e., reservoir) 44 for receiving hydraulic fluid from the auxiliary hydraulic system 10, and a filter 46 in the return line 30 (i.e., between the auxiliary hydraulic system 10 and the reservoir 44).

Again, the reason the auxiliary hydraulic system 10 is necessary is because the pressure in return line 30 is substantial enough to resist a quick pressure drop, therefore preventing the driver cylinder 18 of the post driver from retracting (i.e., dropping) with full force. In other words, the pressure in return line 30, between the original hydraulic system 4-way valve 104 and the skid steer reservoir of the skid steer loader works against dropping of the driver cylinder 18 of the post driver. This limitation would provide a substantial weakness in performance if not overcome by the auxiliary hydraulic system 10. The auxiliary hydraulic system 10 provides sufficiently sized components (i.e., the hydraulic motor 12, hydraulic pump 14, the auxiliary reservoir 24, etc.) to allow the driver cylinder 18 to retract without restriction, because the pressure drop in lines 22 are independent of the pressure drop in the skid steer loader line 30.

While the hydraulic motor 12, hydraulic pump 14, and other components of the auxiliary hydraulic system 10 collectively provide the advantage of allowing the driver cylinder 18 to retract without restriction (i.e., due to pressure in return line 30), obviously providing all these additional components adds to the cost, weight, maintenance, etc. of the overall system.

### SUMMARY

An object of an embodiment of the present invention is to provide a hydraulic system which allows the hydraulic system of a skid steer loader to effectively drive a post driver, without the need for an auxiliary hydraulic system.

Briefly, an embodiment of the present invention provides a hydraulic system for driving a post driver of a skid steer loader. The hydraulic system comprises a master cylinder disposed between a valve, such as a 4-way valve, and the driver cylinder of the post driver. The master cylinder effectively provides that hydraulic fluid from the 4-way valve to the hydraulic system of the skid steer loader can flow freely without needing an auxiliary pump and motor to overcome resistance in the return line.

### BRIEF DESCRIPTION OF THE DRAWINGS

The organization and manner of the structure and operation of the invention, together with further objects and advantages thereof, may best be understood by reference to the following description taken in connection with the accompanying drawings wherein like reference numerals identify like elements in which:

FIG. 1 is a schematic view of a prior art hydraulic system for a skid steer loader and mounted post driver;

FIG. 2 is a schematic view of a more recent prior art hydraulic system for a skid steer loader and mounted post driver;

FIG. 3 is a schematic view of a hydraulic system for a skid steer loader and mounted post driver, wherein the hydraulic system is in accordance with an embodiment of the present invention; and

FIGS. 4-7 are state diagrams relating the system shown in FIG. 3.

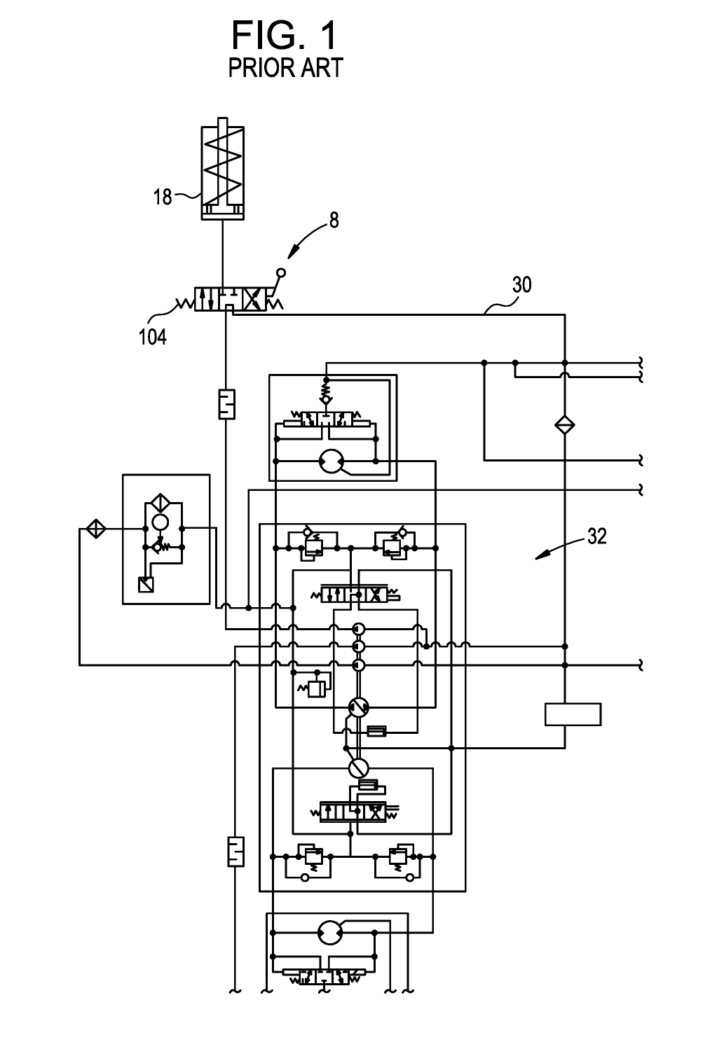

### DESCRIPTION OF ILLUSTRATED EMBODIMENT

While this invention may be susceptible to embodiment in different forms, there is shown in the drawings and will be described herein in detail, a specific embodiment with the understanding that the present disclosure is to be considered an exemplification of the principles of the invention, and is not intended to limit the invention to that as illustrated.

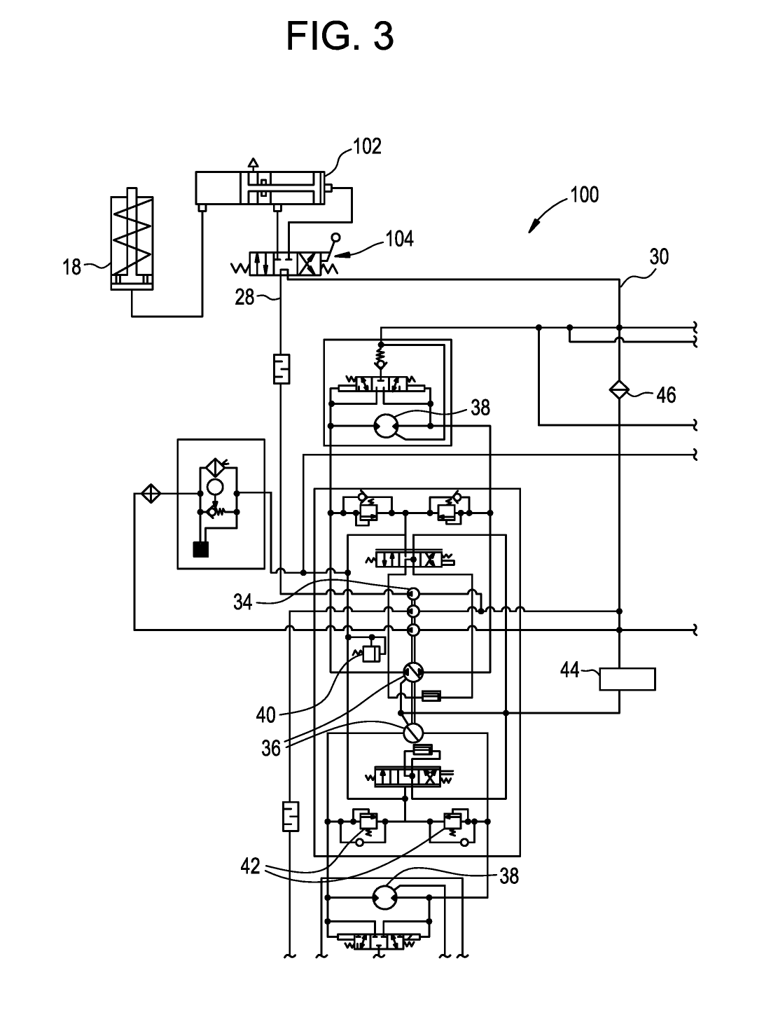

FIG. 3 is a schematic view of a hydraulic system 100 for a skid steer loader and mounted post driver, wherein the hydraulic system 100 is in accordance with an embodiment of the present invention. As shown, the system 100 comprises a master cylinder 102 disposed between a valve 104, such as a 4-way valve, and the driver cylinder 18 of the post driver. Hydraulic lines 28 and 30 of the skid steer loader are connected to the 4-way valve 104. The master cylinder 102 effectively provides that hydraulic fluid from the 4-way valve 104 to the hydraulic system 100 of the skid steer loader can flow freely without needing an auxiliary pump and motor to overcome resistance in the return line 30.

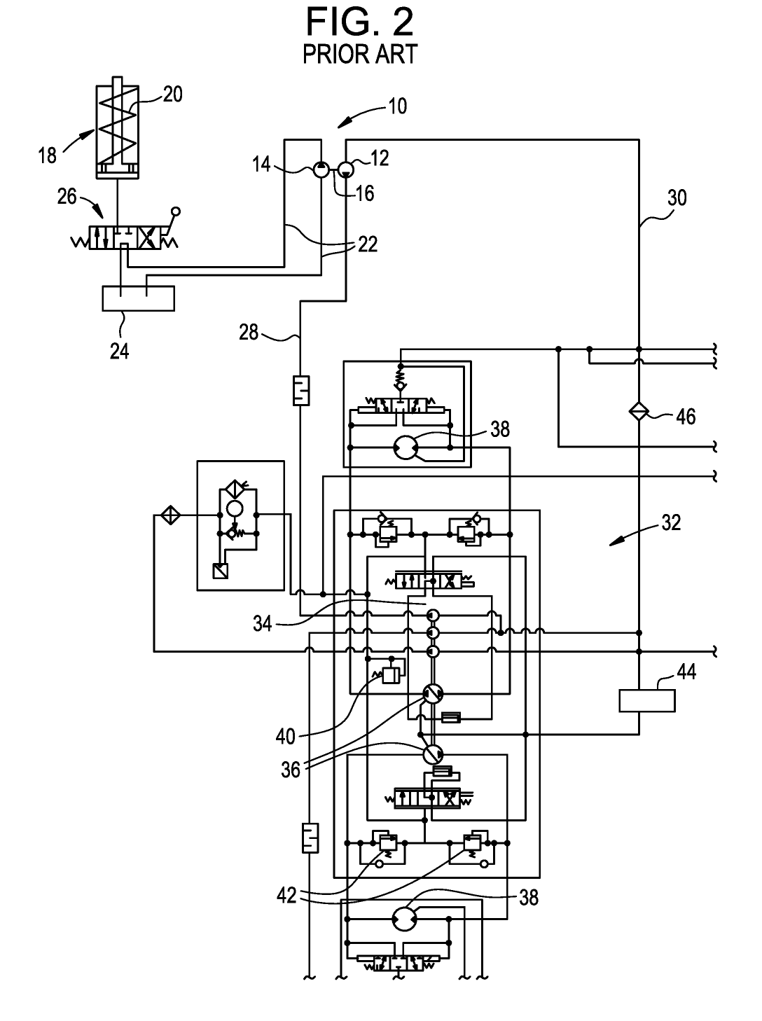

As shown in FIG. 3, much like as is shown in FIG. 2, the hydraulic system 100 of the skid steer loader may include, among other things, a skid steer loader implement pump 34 (i.e., for pumping hydraulic fluid directly to the 4-way valve 104), skid steer loader hydrostatic propel pumps 36 and skid steer loader hydrostatic propel motors 38 (i.e., for propelling the skid steer loader), a charge relief valve 40, replenishing valves 42, a reservoir 44 for receiving hydraulic fluid from the 4-way valve 104, and a filter 46 in the return line 30 (i.e., between the 4-way valve 104 and the reservoir 44).

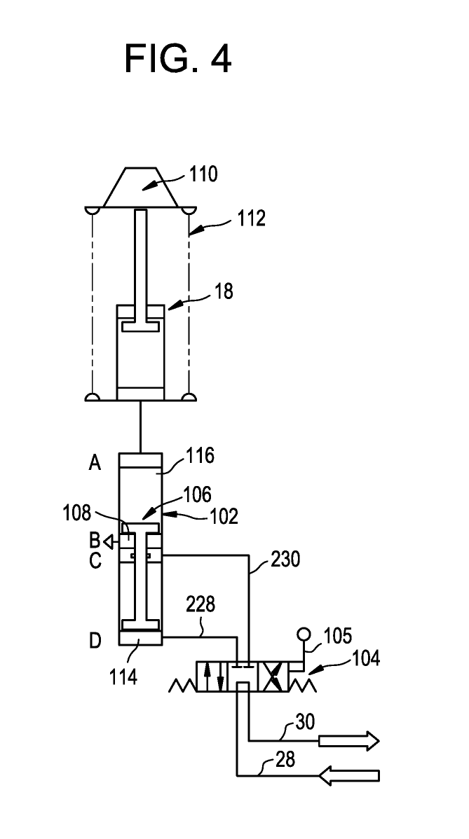

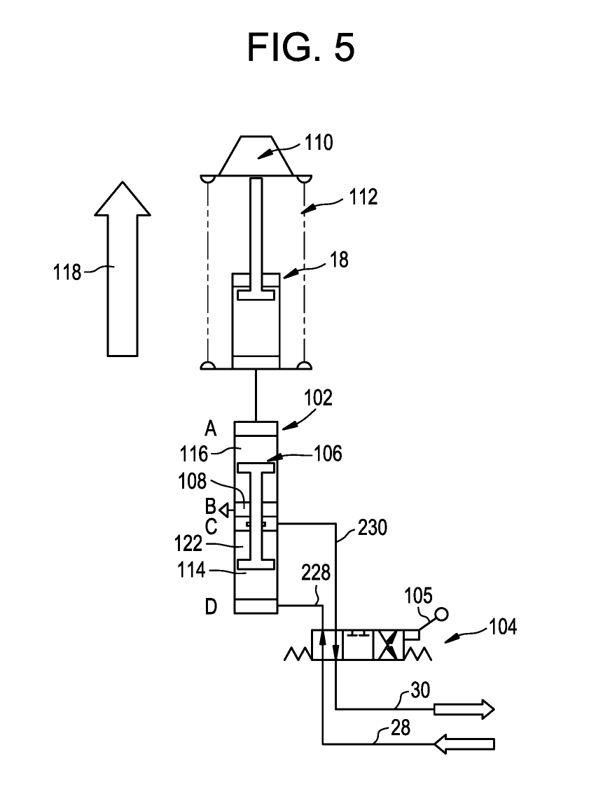

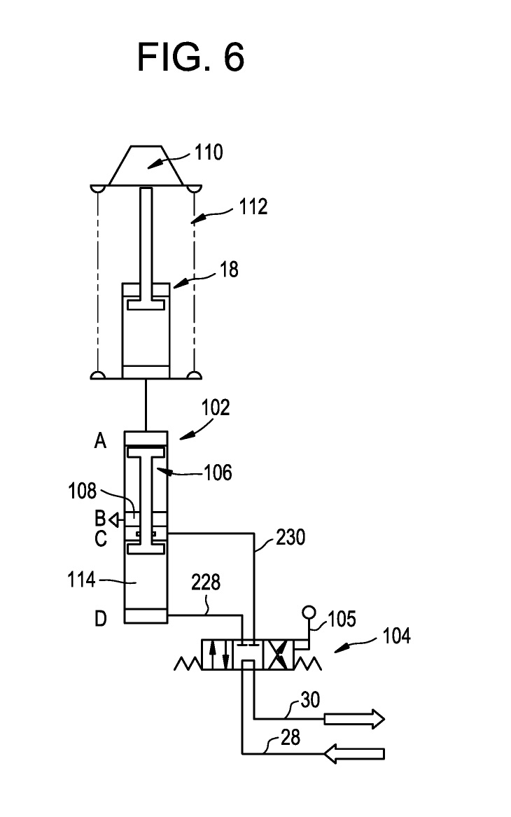

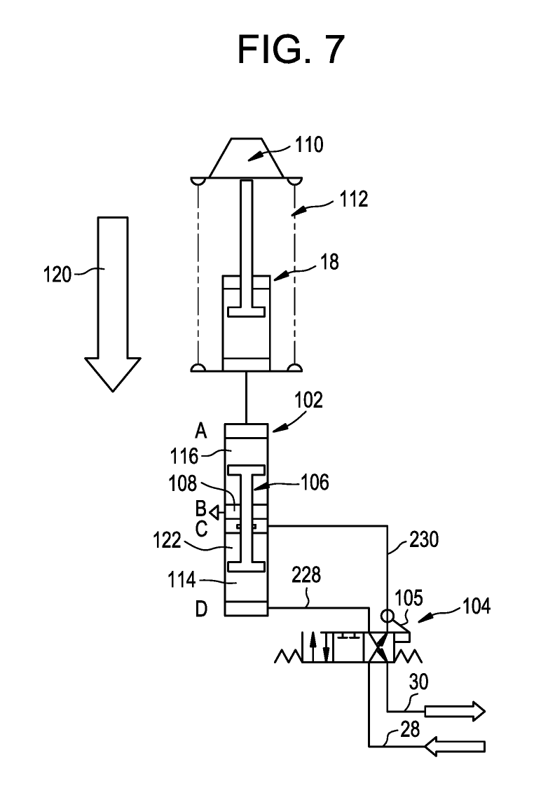

The system 100, and its operation to drive the driver cylinder 18 of the post driver, will now be further explained using state diagrams. These state diagrams are provided in FIGS. 4-7. More specifically, FIG. 4 shows the state in which the system is at rest, FIG. 5 shows the state in which the driver cylinder 18 is being extended (i.e., being driven upward), FIG. 6 shows the state in which the driver cylinder 18 is fully extended (i.e., driven fully upward), FIG. 7 shows the state in which the driver cylinder 18 is retracting (i.e., moving downward).

FIG. 4 will be described first. As shown, the master cylinder 102 preferably comprises a double-sided piston 106 and four ports (identified A, B, C and D in FIGS. 3-6)—a port (A) which provides hydraulic fluid to and receives hydraulic fluid from the driver cylinder 18 (since the driver cylinder 18 is a single acting cylinder, no additional port connections are needed), a port (B) which vents to atmosphere (because the corresponding chamber 108 of the master cylinder 102 only exchanges air during operation of the master cylinder 102), a port (C) which communicates hydraulic fluid to and from the 4-way valve 104 (along line 230) (i.e., and thereafter back to the skid steer loader hydraulic system along return line 30), and a port (D) which communicates hydraulic fluid to and from the 4-way valve 104 (along line 228) (i.e., to and from the skid steer loader hydraulic system along supply line 28).

As shown in FIG. 4, the driver cylinder 18 includes a mass 110 for impact (i.e., for impacting a post being driven into the ground) as well as a spring return 112 which comprises one or more springs for driving the mass 110 downward. The 4-way valve 104 includes a handle 105 for human interaction.

In operation, hydraulic fluid flow from the skid steer loader hydraulic system enters the 4-way valve 104 and, due to the tandem center arrangement of the 4-way valve 104, the flow returns to the skid steer loader hydraulic system tank (i.e., reservoir 44, as shown in FIG. 2) along return line 30. During this state, the master cylinder 102 and the driver cylinder 18 are in the fully retracted position. With the 4-way valve 104 centered, hydraulic fluid flow from the skid steer loader hydraulic system is prevented from actuating the master cylinder 102.

With the 4-way valve 104 shifted (via handle 105) as shown in FIG. 5, hydraulic fluid flow from the skid steer loader hydraulic system is directed into the lower chamber 114 of the master cylinder 102 (via port D). Hydraulic fluid flow out of chamber 122 of the master cylinder 102 is directed back to the 4-way valve 104 via line 230, then back to the skid steer loader tank (i.e., reservoir 44 in FIG. 3). The pressurized flow entering the master cylinder 102 via chamber 114 extends the piston 106 of the master cylinder 102 (the direction of travel of the driver cylinder 18 is indicated with arrow 118 in FIG. 5). The piston 106 is connected to the upper chamber 116 of the master cylinder 102. As the piston 106 of the master cylinder 102 extends, the hydraulic fluid in the upper chamber 116 of the master cylinder 102 is displaced into the driver cylinder 18, thus extending the driver cylinder 18 (the master cylinder 102 and the driver cylinder 18 move in concert). The directional control of the driver cylinder 18 is governed by control of the master cylinder 102 via the 4-way valve 104.

FIG. 6 shows the state in which the driver cylinder 18 is fully extended (i.e., driven fully upward). As a result of the 4-way valve 104 being shifted such that the master cylinder 102 travels full stroke, the driver cylinder 18 will extend fully. In this state, no movement of the system occurs because ports C and D of the master cylinder 102 are effectively blocked (i.e., via the 4-way valve 104). The driver cylinder 18 is preferred to be fully extended during operation to allow maximum impact to the post when the driver cylinder 18 retracts.

FIG. 7 shows the state in which the driver cylinder 18 is retracting (i.e., moving downward) (the direction of travel of the driver cylinder 18 is indicated with arrow 120 in FIG. 7). By positioning the 4-way valve 104 in the opposite direction (using handle 105), hydraulic fluid flow from the skid steer loader hydraulic system enters the master cylinder 102 on the upper side 122 of the lower chamber of the master cylinder 102. This drives the piston 106 of the master cylinder 102 in the retracting direction (i.e., in the same direction as arrow 120). As this occurs, the upper chamber 116 of the master cylinder 102 decreases in volume allowing the driver cylinder 18 to also retract at a rapid rate. The retraction velocity of the driver cylinder 18 is aided by the spring return 112 (i.e., one or more extension springs) and the mass 110 of the driver cylinder 18. Therefore, by driving the master cylinder 102 via the skid steer hydraulic system flowing oil into chamber 122 of the master cylinder 102 and forcing oil out of chamber 114 of the master cylinder 102 to return rapidly into the skid steer hydraulic system via line 228, the 4-way valve 104 and ultimately line 30 of the skid steer hydraulic system, the restriction in the return line 30 of the skid steer hydraulic system is obviated and a very fast retraction can be achieved, improving the impact performance of the system. Also, by comparing FIG. 2 to FIG. 3, one can see that the system 100 in accordance with an embodiment of the invention allows for the elimination of, for example, an auxiliary motor 12, auxiliary pump 14, auxiliary coupling 16, and auxiliary system hoses 22, thereby providing a system that provides reduced cost, weight, maintenance, etc.

While a specific embodiment of the invention has been shown and described, it is envisioned that those skilled in the art may devise various modifications without departing from the spirit and scope of the present invention.

What is claimed is:

1. A post driver hydraulic system for driving a post driver of a skid steer loader, said post driver comprising a driver cylinder, said skid steer loader comprising a skid steer loader hydraulic system, said post driver hydraulic system comprising: a valve; a master cylinder disposed between the valve and the driver cylinder of the post driver, wherein the master cylinder is configured to provide that hydraulic fluid from the valve flows freely to the skid steer loader hydraulic system.

2. The post driver hydraulic system as recited in claim 1, wherein the valve comprises a 4-way valve.

3. The post driver hydraulic system as recited in claim 1, further comprising a return line wherein the system is configured to provide that hydraulic fluid from the valve flows freely along the return line to the skid steer loader hydraulic system without needing an auxiliary pump and motor to overcome resistance in the return line.

4. The post driver hydraulic system as recited in claim 1, further comprising hydraulic lines which are connected to the valve.

5. The post driver hydraulic system as recited in claim 1, wherein the skid steer loader hydraulic system comprises a skid steer loader implement pump which is configured to pump hydraulic fluid directly to the valve, hydrostatic propel pumps and motors which are configured to propel the skid steer loader, a charge relief valve, replenishing valves, and a reservoir which is configured to receive hydraulic fluid from the valve of the post driver hydraulic system.

6. The post driver hydraulic system as recited in claim 1, wherein the master cylinder comprises a double-sided piston and four ports, wherein the four ports comprise a first port which provides hydraulic fluid to and receives hydraulic fluid from the driver cylinder, a second port which vents to atmosphere, a third port which communicates hydraulic fluid to and from the valve, and a fourth port which communicates hydraulic fluid to and from the valve.

7. The post driver hydraulic system as recited in claim 1, wherein the driver cylinder comprises a mass for impact as well as a spring return which comprises at least one spring for driving the mass downward, and wherein the valve comprises a handle for human interaction.

8. The post driver hydraulic system as recited in claim 1, wherein the system is configured such that hydraulic fluid flow from the skid steer loader hydraulic system enters the valve, and due to a tandem center arrangement of the valve, the flow returns to a reservoir of the skid steer loader hydraulic system, wherein the system is configured such that when the valve is centered, hydraulic fluid flow from the skid steer loader hydraulic system is prevented from actuating the master cylinder.

9. The post driver hydraulic system as recited in claim 1, wherein the system is configured such that when the valve is shifted, hydraulic fluid flow from the skid steer loader hydraulic system is directed into a lower chamber of the master cylinder, and wherein hydraulic fluid flow out of an upper chamber of the master cylinder is directed back to the valve, and thereafter back to a reservoir of the skid steer loader hydraulic system, wherein pressurized flow entering the master cylinder extends the piston of the master cylinder, wherein as the piston of the master cylinder extends, hydraulic fluid in the upper chamber of the master cylinder displaces into the driver cylinder, thus extending the driver cylinder, wherein directional control of the driver cylinder is governed by control of the master cylinder via the valve.

10. The post driver hydraulic system as recited in claim 1, wherein the system is configured such that as a result of the valve being shifted such that the master cylinder travels full stroke, the driver cylinder extends fully, wherein no movement of the system occurs because ports of the master cylinder are blocked via the valve.

11. The post driver hydraulic system as recited in claim 1, wherein the system is configured such that the valve is configured to provide that hydraulic fluid from the skid steer loader hydraulic system flows into a lower chamber of the master cylinder, wherein a piston of the master cylinder is driven in a retracting direction, wherein an upper chamber of the master cylinder decreases in volume thereby allowing the driver cylinder to retract quickly.

12. The post driver hydraulic system as recited in claim 1, wherein the valve comprises a 4-way valve, wherein the master cylinder comprises a double-sided piston and four ports, wherein the four ports comprise a first port which provides hydraulic fluid to and receives hydraulic fluid from the driver cylinder, a second port which vents to atmosphere, a third port which communicates hydraulic fluid to and from the valve, and a fourth port which communicates hydraulic fluid to and from the valve.

13. The post driver hydraulic system as recited in claim 12, wherein the system is configured such that hydraulic fluid flow from the skid steer loader hydraulic system enters the 4-way valve, and due to a tandem center arrangement of the 4-way valve, the flow returns to a reservoir of the skid steer loader hydraulic system, wherein the system is configured such that when the valve is centered, hydraulic fluid flow from the skid steer loader hydraulic system is prevented from actuating the master cylinder.

14. The post driver hydraulic system as recited in claim 12, wherein the system is configured such that when the 4-way valve is shifted, hydraulic fluid flow from the skid steer loader hydraulic system is directed into a lower chamber of the master cylinder, and wherein hydraulic fluid flow out of an upper chamber of the master cylinder is directed back to the valve, and thereafter back to a reservoir of the skid steer loader hydraulic system, wherein pressurized flow entering the master cylinder extends the piston of the master cylinder, wherein as the piston of the master cylinder extends, hydraulic fluid in the upper chamber of the master cylinder displaces into the driver cylinder, thus extending the driver cylinder, wherein directional control of the driver cylinder is governed by control of the master cylinder via a handle of the 4-way valve.

15. The post driver hydraulic system as recited in claim 12, wherein the system is configured such that as a result of the 4-way valve being shifted such that the master cylinder travels full stroke, the driver cylinder extends fully, wherein no movement of the system occurs because ports of the master cylinder are blocked via the 4-way valve.

16. The post driver hydraulic system as recited in claim 12, wherein the system is configured such that the 4-way valve is configured to provide that hydraulic fluid from the skid steer loader hydraulic system flows into a lower chamber of the master cylinder, wherein a piston of the master cylinder is driven in a retracting direction, wherein an upper chamber of the master cylinder decreases in volume thereby allowing the driver cylinder to retract quickly.
